(19) United States
(12) Patent Application Publication
(10) Pub. No.: US 2018/0225129 A1
(43) Pub. Date: Aug. 9, 2018

(54) MOBILE APPLICATION PUBLISHING

(71) Applicant: International Business Machines Corporation, Armonk, NY (US)

(72) Inventors: Stefan Behl, Holzgerlingen (DE); Uwe Hansmann, Tuebingen (DE); Timo Kussmaul, Boeblingen (DE); Thomas Steinheber, Stuttgart (DE); Thomas Stober, Herrenberg (DE)

(21) Appl. No.: 15/427,236

(22) Filed: Feb. 8, 2017

(51) Int. Cl. G06F 9/44; H04L 29/08; G06F 3/0482; G06F 3/0484

(52) U.S. Cl. CPC G06F 9/4443; H04L 67/306; G06F 3/04847; H04L 67/06; G06F 3/0482; H04L 67/02

(57) ABSTRACT

A method for distributing a content container to a user device may be provided. The method comprises creating target web content in a web content management system, packaging the target web content into the content container, and offering the target web content in the content container for downloading to the user device. The target web content comprises event rules adapted for changing rendered content displayed at interpretation time of the target web content without a connection between the user device and the content management system, multiple variations of the target web content adapted for personalizing the rendered target web content offline, wherein the personalization comprises determining which variation of the target web content is being rendered depending on an external parameter and the event rules and, a buffer for storing an interaction response of an interaction with the target web content.

### FIELD OF THE INVENTION

The invention relates generally to a method for publishing content to a mobile device, and more specifically, to methods, systems, and computer program products for distributing a content container to a user device.

### BACKGROUND

Although portal technology and web content management has been an established technique for years, in modern portal and web content sides there is a shift of technology to be found: a classic portal approach aggregates content pages at one time from application components and content based on individual user preferences and dynamic targeting rules. Each user may receive a personalized portal page, which may be assembled only for him, his context and his preferences at runtime.

Next generation web sites attempt to optimize runtime behavior by pre-rendering the pages within a “publishing” step. Rather than executing complex aggregation logic, the publishing step creates more or less static markup language constructs, which can simply be retrieved by the user's browser. Some level of personalization or access control can be reflected by publishing slightly different variations of the page for different user segments. If there are any remaining variabilities, those would be added directly inside the user's browser using client-side (e.g., AJAX) mechanisms, which are typically implemented in JavaScript. However, all of these techniques are intended for server-side usage.

However, off-line capabilities of mobile apps and content rendering are currently limited in terms of interaction, user experience and a reflection of environmental parameters.

### SUMMARY

According to one aspect of the present invention, a computer-implemented method for distributing a content container to a user device may be provided. The method may comprise creating target web content in a web content management system and packaging the target web content into the content container. This content container with the target web content may be offered for downloading to the user device. The target web content may comprise event rules adapted for changing rendered content displayed at interpretation time of the target web content without a connection between the user device and the content management system. The target web content may also comprise multiple variations of the target web content adapted for personalizing the rendered target web content offline. The personalization may comprise determining which variation of the target web content may be rendered depending on an external variable parameter and the event rules. Furthermore, the target web content may comprise a buffer for storing an interaction response of an interaction with the target web content.

According to another aspect of the present invention, a system for distributing a content container to a user device may be provided. The system may comprise a web content management system adapted for creating target web content and a packaging unit adapted for packaging the target web content into the content container. The system may also comprise an offering module adapted for offering the target web content in the content container for downloading to the user device. In the context of such an environment, the target web content may comprise at least one event rule adapted for changing rendered content displayed at interpretation time of the target web content without a connection between the user device and the content management system, multiple variations of the target web content adapted for personalizing the rendered target web content offline, wherein the personalization may comprise determining which variation of the target web content is being rendered depending on external variables and the event rules, as well as a buffer for storing an interaction response of an interaction with the target web content.

It may be noted that the user device may be a mobile device, like a smartphone or any other mobile user device, with a data transceiver.

Furthermore, embodiments may take the form of a related computer program product, accessible from a computer-usable or computer-readable medium providing program code for use, by or in connection with a computer or any instruction execution system. For the purpose of this description, a computer-usable or computer-readable medium may be any apparatus that may provide capability for storing, communicating, propagating or transporting the program for use, by or in a connection with the instruction execution system, apparatus, or device.

### BRIEF DESCRIPTION OF THE SEVERAL VIEWS OF THE DRAWINGS

It should be noted that embodiments of the invention are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, but to which the invention is not limited.

Preferred embodiments of the invention will be described, by way of example only, and with reference to the following drawings:

FIG. 1 shows a block diagram of an embodiment of the inventive method for distributing a content container to a user device.

FIG. 2 shows a block diagram of an embodiment of server side and client side implementation details.

FIG. 3 shows a block diagram of an embodiment of a system for distributing a content container to the user device.

FIG. 4 shows an embodiment of a computer system being instrumental in implementing the proposed method of FIG. 1 and/or embedding parts or all of the system according to FIG. 3.

### DETAILED DESCRIPTION

In the context of this description, the following conventions, terms and/or expressions may be used:

The term ‘content management system’ (CMS) may denote a system for managing digital information items, e.g., in form of web pages. Creating and modifying of content may be supported. Typically, a CMS comprises web-based publishing, format management, history editing and version control, indexing, search, and retrieval. By their nature, content management systems support the separation of content and presentation. A web content management system (WCM or WCMS) may be understood as a CMS designed to support the management of the content of web pages. Web content may include text and embedded graphics, photos, videos, audio, maps, and codes (e.g., for applications) that displays content or are designed for an interaction with the user. Such a content management system (CMS) may typically have two major components: (a) a content management application (CMA) as the front-end user interface that may allow a user, even with limited expertise, to add, modify and remove content from a website without the intervention of a webmaster. (b) A content delivery application (CDA) that may compile that information and may update the website.

The term ‘target web content’ may denote web content in the just discussed sense, wherein the web content is targeted for a specific user and/or a specific date and/or time and/or a specific context. User profiles and selection rules may be used for the selection of the targeted content for a specific user and context. Besides normal content, the target web content may also comprise event rules, rules for selecting a specific page, and a buffer for storing a reaction of a user in an intermediary storage.

The term ‘event rules’ may denote predefined reactions in the occurrence of a specific event. The event may be triggered by sensors and their respective measurement values. In the context of this document, sensors may take a variety of different forms like a GPS sensor (global positioning system), a temperature sensor, a humidity sensor, an orientation sensor, a blood pressure sensor, a clock delivering date and time, or any other event triggered by external environmental parameters. Also the status of the battery of a mobile device or a storage status may be used as sensor data.

The term ‘interpretation time’ may denote a time when a web page may be rendered by an HTTP (HyperText Transfer Protocol) server. A plurality of data may be pulled together to render and display the related content. The interpretation time may be understood in contrast to the creation time of specific web content.

The term ‘variation of target web content’ may denote possible alternatives to a given interlinked set of web pages relating to a specific theme. As an example, a theme may be a city guide of one area of the city. A variation of such a target web content may be a city guide of another area of the same city. Another example may be a city guide for activities to be performed during the day, whereas a variation of such a target web content may relate to activities to be done at night in the same city.

The term ‘HTML’ may stand for HyperText Markup Language, e.g., in version 4 or 5, i.e., HTML5, or any later version.

The term ‘JavaScript’ may denote the well-known high-level, dynamic, untyped and interpreted programming language used in the context of web content. JavaScript relates to ECMAScript (European computer Manufacturers Association). Currently, it is used in version 1.8. The here proposed concept may be implemented with earlier, the current and later version of JavaScript. A person of skill in the art knows also how to implement the here proposed concept with variations of JavaScript or alternatives.

The term ‘CSS’ (Cascading Style Sheets) may denote the WWWC (World Wide Web Consortium) stylesheet language used for describing the presentation of a document written in a markup language, e.g., HTML. Currently, the version CSS4 is used. The here proposed concept may be implemented with an earlier, the current or later versions of CSS.

The term ‘hap-server’ may denote an application—often being executed on a dedicated computer system—that may process requests via HTTP.

The proposed method for distributing a content container to a user device may offer multiple advantages and technical effects:

The proposed technology gives off-line users of mobile devices a new and extended user experience. On the one hand, the user may decide to download prepackaged web content according to different themes and topics and for different contexts based on profile data and individual user-related rules. On the other hand, the content presented and/or pushed to the browser of the mobile device in an off-line status is influenced by external events. These external events are not triggered via a connection to a mobile network—because the user device is off-line—but by measured parameter values from sensors from within the mobile device or received by the mobile device.

Additionally, the newly proposed concept also allows interaction possibilities with interactive websites—such as e-commerce shopping servers—even if the mobile device is off-line. After the mobile device goes online again via a mobile or wired line Internet connection, the intermediate lease stored responses to a shopping catalog from the off-line time will be transmitted to the bank and e-commerce system in order to complete the transaction foe, e.g., a quasi-online purchase.

In addition to simple web content, the proposed concept also allows to package applications into the content container for a download to the mobile device for off-line usage. This may open possibilities for advertisers, but also for the user of the mobile device itself. He may be given the opportunity to simply test some applications on his user device even if being off-line.

The concept of the content container may also allow only downloading data or information to target web content that has not been downloaded in the content container to the user device. This may save download-time as well as keep the content container in the user device current.

Downloaded rules, as part of the content container, may be event sensitive in the sense that certain target web content may have a higher priority in a list of possible displayed content when being off-line. The rules may also be used to prioritize target web content in the content container if the user device is in an off-line status. Such prioritization may depend on measured parameter values of sensors of the user device or parameter values received by the mobile device, e.g., from a heartbeat sensor, a blood pressure sensor, a blood sugar sensor, measured weather data (temperature, humidity), an illumination level, time within a day, day of the week (a differentiation between workdays and weekend days may be done), an altitude sensor, an appointment noted in a calendar of the user device, and many more sensor data available to the user device. It may be noted that all of the sensor data may be available in an off-line status of the user device.

The option to download a plurality of different content containers with different target web content offers the possibility to select different scenario content within the user device. The user may—being off-line—select a different scenario during his working hours compared to his leisure time.

It may also be possible to prioritize alternative target web content based on a recent usage of the web content in general (online and off line). Such a behavior may be analyzed and stored in the user profile. Based on threshold probabilities alternative target web content may be packaged in the content container. A plurality of different scenarios may be derived from this. One example may be to package different content into the content container whether the user of the user device may be on its way as a tourist or business traveler. The data for this preselection of prepackaged target web content may be located using data from calendar entries in the profile of the user. Other sources for the calendar entries—calendar entries in the user device or in a different application, e.g., a cloud computing service—may also be reflected.

The option to compress the target web data in the content container allows reduced transmission times between the content management system and the mobile device. Any compression format is possible (e.g., ZIP).

According to one preferred embodiment of the method, the interaction response stored in the buffer may be used to interact with an interaction target when a network connection to the user device has been established again (after it has been interrupted before). Such an interaction target may be, e.g., a shopping app (application) which typically requires an online connection and transaction capabilities with a backend system. However, a part of the shopping catalogue may be downloaded to the user device as part of the target web content. If the user device goes off-line, a user may not interact online with a shopping catalogue. However, the downloaded part of the shopping catalogue may be displayed on the user device and may allow an interaction. These inputs may be stored in the buffer. The buffer may interact with the backend shopping system after the user device may be online again. From the buffer, the shopping details may be uploaded to the shopping app. The user may have the same interaction experience with the app compared to the online shopping catalogue.

Thus, according to an optional embodiment of the method, the interaction response may be targeted to a selection option relating to products and/or services. Hence, the user may do his e-commerce shopping without being online. Orders may be executed after the user device may be online again. The interaction with the backend system may either be performed by a runtime environment of the user device or via the CMS.

According to one additionally preferred embodiment of the method, the target web content may be created using at least one selected out of the group comprising plain HTML, JavaScript, and CSS. Hence, the proposed concept may rely on standard web tools. No special and seldom used tools may be required.

According to one advantageous embodiment of the method, the external variable may comprise one or more selected out of the group comprising a date, a point in time, a location (e.g., given in GPS (global positioning system) coordinates), measured temperature, a measured heartbeat rate, measured humidity, and the like. Basically, a device sensor may deliver an external parameter value that may be used as a selection parameter. This may allow a high flexibility of the proposed concept.

The measured temperature may be the environmental temperature or the skin temperature of the user of the user device. In a similar way, the heartbeat rate of the user may be measured. For this purpose, the user device may be connected wirelessly Bluetooth, Wi-Fi, or other suitable mechanism) to a related sensor.

According to another advantageous embodiment of the method, the creation of the target web content may be dependent on a user profile or other personalization rules. Thus, the content being packaged into a content container may be individualized depending on preferences of a user, a location, a date, a time in the year, context and so on.

According to one advanced embodiment of the method, the packaging the target web content into the content container also comprises packaging an application to be executed on the user device into the content container. This may extend the proposed concept in that not only static or dynamic content may be packaged to the content container but also mobile device-specific applications.

According to one further advanced embodiment of the method, the packaging the target web content may be prepared individually for each user requesting the package. This may be performed based on user preferences and on evaluation of personalization rules on the web content management server. The selection of this specific content may be done on request of the user device and just before the content container may be downloaded to the user device. This way, the most recent rules and personalization priorities may be reflected in building the elements for the target web content. In another implementation, the target web content may be generated and packaged into the content container in a background process. This way, a basic set of target web content may be prepackaged into the content container. It may be individualized at download time based on the latest user preferences and personalization rules and may have performance advantages.

According to one embodiment of the method, the target web content may be interpreted by a local http-server for rendering the target web content on the user device. Thus, the standard elements typically used for web browsing on mobile devices may be used.

In the following, a detailed description of the figures will be given. All instructions in the figures are schematic. Firstly, a block diagram of an embodiment of the inventive method for distributing a content container to a user device is given. Afterwards, further embodiments, as well as embodiments of the system for distributing a content container to a user device, will be described.

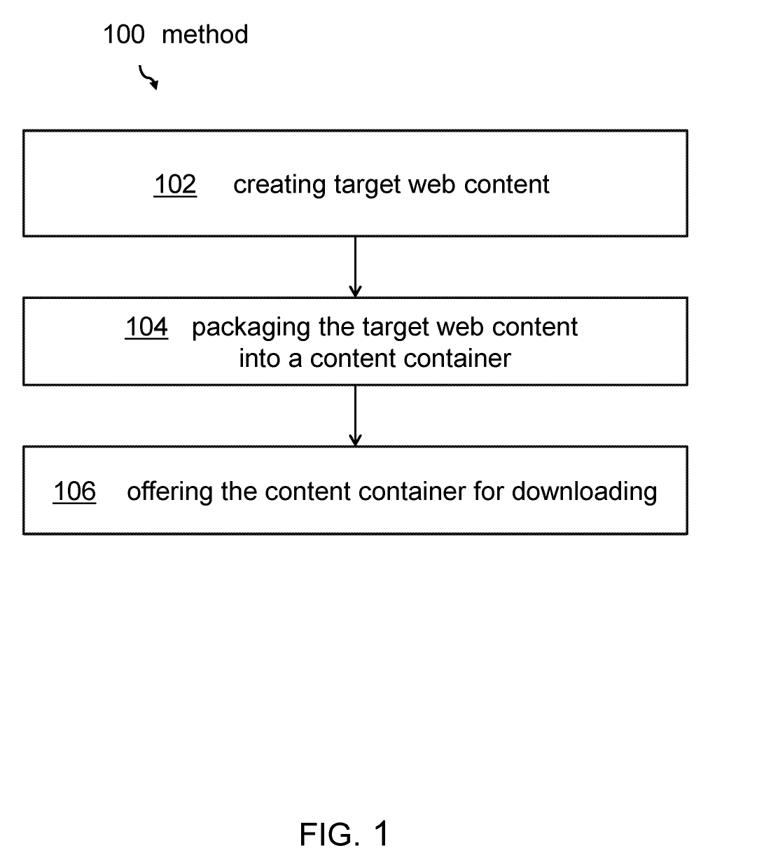

FIG. 1 shows a block diagram of an embodiment of the computer-implemented method 100 for distributing a content container to a user device. The user device may be a mobile user device, like a smart phone, a tablet computer, a phablet or any other mobile computing device. The method comprises creating target web content in a web content management system at 102, and packaging the target web content into the content container at 104. As discussed above, for this process plain HTML, JavaScript and/or CSS techniques may be used.

Furthermore, the method comprises offering the target web content in the content container for downloading to the user device at 106. The target web content comprises event rules adapted for changing rendered content displayed at interpretation time of the target web content without any connection between the user device and the content management system. This feature may be used if no mobile or wired data connection to the user device may be available or the user may decide to disable the mobile Internet connection because of high data traffic cost or an avoidance of location tracking by certain installed applications on the mobile device.

Additionally, the target web content may also comprise multiple variations of the target web content adapted for personalizing the rendered target web content offline. This may depend on a personalization process which comprises determining which variation of the target web content is being rendered depending on at least one external parameter value. Such an external parameter value may be measured by a sensor. The sensor may measure environmental parameters or user-specific parameters.

The target web content comprises also a buffer for storing an interaction response of an interaction with the target web content. As explained above, this may provide the same or a comparable interactive experience as if being online, even if the user device is operated in off-line mode.

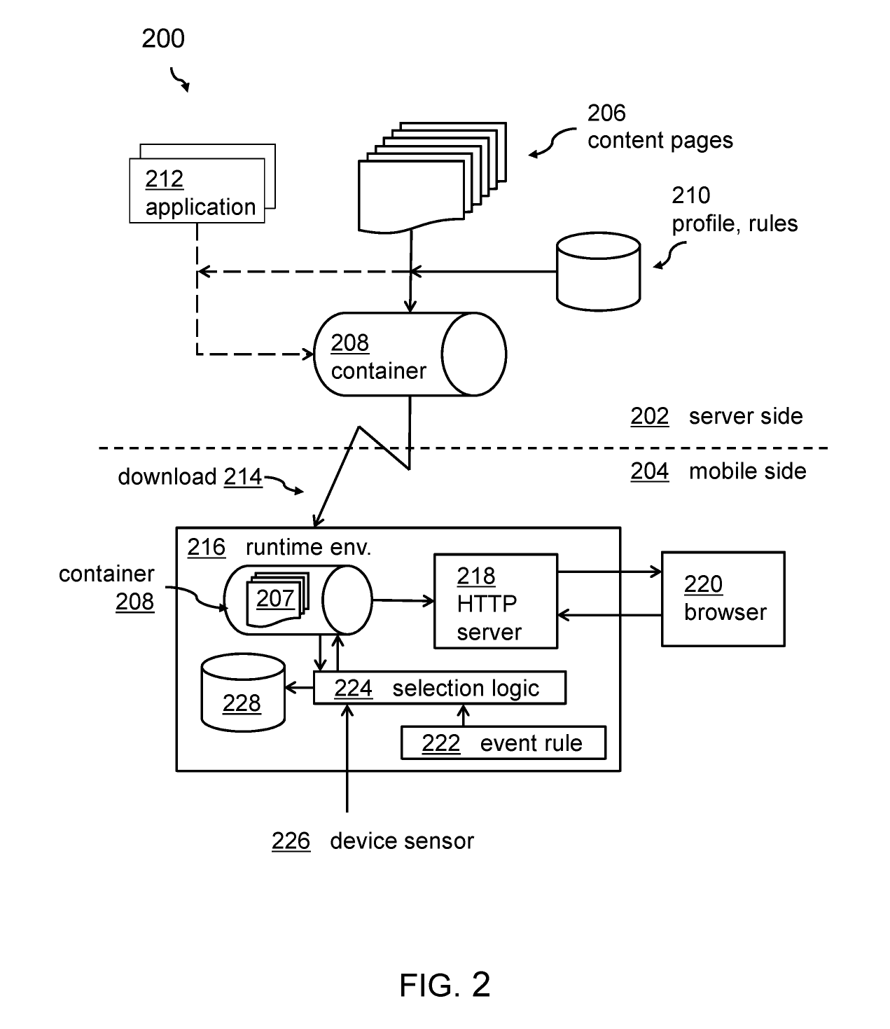

FIG. 2 shows a block diagram 200 of an embodiment of server side 202 and client side 204 (user device side) implementation details. In a content management system or web content management system (not shown), digital content may be available in terms of content pages 206. The digital content may be any content in the form of text, graphics, pictures, videos, sound and all other known digital content categories. No limitations apply. Out of these content pages 206, a subset 207 of content pages 206 may be packaged into the content container 208. This may be done in a backend process, so that the content container 208 may be offered to an end user device actively. Different content container 208 with different subsets of content pages may be offered for download. On the other side, the user device may actively request a content container 208 comprising specific content. The selection of the content pages 206 for preparing and packaging the target web content into the content container 208 may reflect preferences received from the mobile user device or, it may be controlled by a user profile 210 stored in the content management system. Additionally, also time-independent or time-dependent as well as user-independent or user-dependent rules may be reflected when selecting content pages 206 to be packaged into the content container 208. The user may influence the selection of the target web content via a user interface. It may also be possible to download more than one content container to the user device. The user device may have the option to switch between different content containers. This way, the same event may be interpreted in different contexts.

Optionally, also one or more application 212 for the mobile user device may be packaged as target web content into the content container 208. The user device may signal a preference, when and which applications 212 shall be packaged into the content container 208 (shown as dashed lines from the profile/roots 210 to the loading of an application 212 to the content container 208).

As long as the mobile user device is online, the content container may be downloaded, at 214, into a runtime environment 216 in the mobile user device. At this point, the mobile data connection between the mobile user device and other backend services, like the content management system, may be cut. The user device may operate in a stand-alone mode. However, from a user experience standpoint, the user may still experience “normal” interaction with web content such as if the user device would be online. The stored content pages 206 in the content container 208 in the runtime environment 216 may be rendered using the HTTP server 218, which may be part of the runtime environment 216 or, may be implemented outside the runtime environment 216 of the user device, so that the rendered content may be displayed in a window of a browser 220.

Specific content pages 206 may be pushed to the browser 220 based on event rules 222 which influence selection logic 224 in the runtime environment 216. Event rules 222 may be influenced by inputting data from one or more device sensors 226. Any measurement sensor being available in the user device may be used as parameter input data for the selection logic.

If the user may be in a certain environment at certain GPS coordinates—let's assume in front of a historic building on a city tour—the selection logic may receive the GPS coordinates and may automatically select the related web content pages explaining the history of the historic building. If the user carrying the user device may be on a university campus—also determined by GPS coordinates—a map of the university campus may be pushed from the content container 208 to the browser 220.

If during lunchtime—signaled by a certain hour, such as noontime, as a sensor signal from a clock—restaurants in the surrounding area of the user device may be offered in the browser 220 out of the content of the content container 208.

It may also be possible that part of a shopping catalog may have been downloaded to the content container 208 in the runtime environment. However, no direct online shopping may be possible because the mobile user device may not be connected to a mobile communication net (mobile Internet). However, the user may interact with the downloaded content pages 206 in the content container 208, which may happen to be e-commerce shopping pages, and may click on certain items in order to purchase these. The selections may be stored in the buffer 228 which may also be part of the content container (for figure clarity reasons not shown as part of the content container). Alternatively, the target web content may comprise the buffer as a return channel In case the mobile user device may have a data connection again at least the buffer 228 may be uploaded to the server side 202, e.g., to the content management system. According to the content and the selection stored in the buffer, the CMS may now act with its actual online e-commerce shopping website in order to perform the intended transactions which have been stored in an intermediate form in the buffer 228 when the user device was off-line. Alternatively, the runtime environment may interact directly with the backend shopping system.

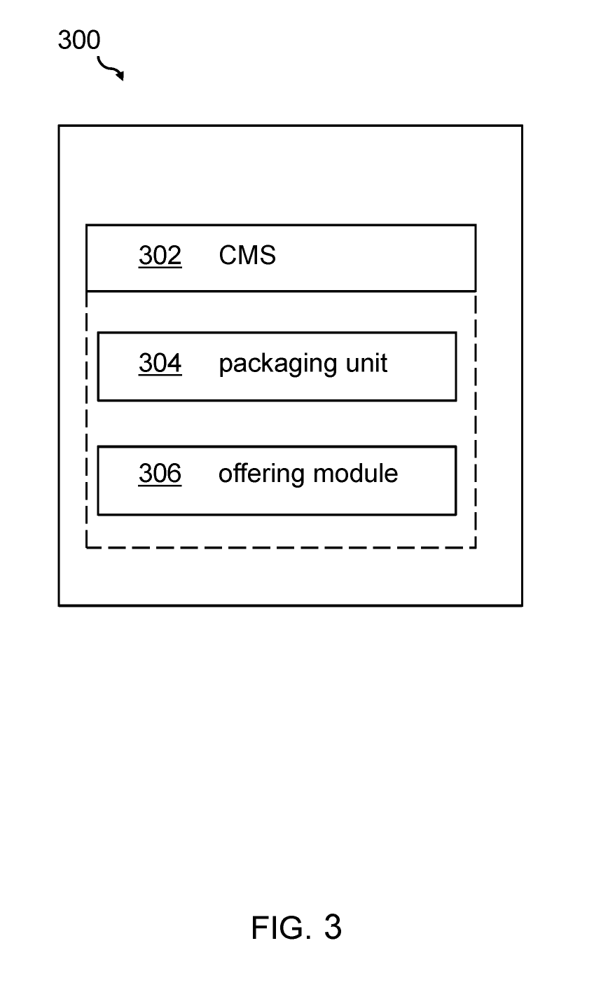

FIG. 3 shows a block diagram of an embodiment system 300 for distributing a content container to a user device. The system comprises content management system 302—in particular a web content management system—adapted to create target web content. The target web content is addressed for a specific user using rules and user profiles as well as historical data of the user in order to select appropriate content from webpages. The system also comprises a packaging unit 304 adapted to package the target web content into the content container. This may be done in the compressed format, e.g., as ZIP files. Different target web content groups may be built, wherein a target web content group relates to a certain context tourist context vs. business traveler context). The packaging unit is also adapted to collect and package alternative versions of the target web content into the content container. Those different versions may be selectively triggered in the runtime environment of the user device; it may be influenced by a reception of data and triggers external events which may be measured by sensors.

The system comprises additionally an offering module 306 which is adapted to offer the target web content in the content container for downloading to the user device. As mentioned above, different versions of the content container may be available for downloading. The downloading may be performed wire-based or wirelessly. There is also an option to only download deltas to a content container which has already been downloaded to the user device.

The content container comprises event rules, multiple variations of the target web content and, a buffer for return messages. The event rules are instrumental for changing rendered content displayed at interpretation time of the target web content without a connection between the user device and the content management system; thus if the (mobile) network is down or the user of the user device decided not to use the mobile communication facility.

The multiple variants of the target web content may be designed for a personalization of the target web content if being offline. The personalization comprises determining which variation of the target web content is being rendered depending on externally measured parameters and related event rules.

Furthermore, the content container comprises a buffer for storing an interaction response of an interaction with the target web content or other web services. Thus, the user of the user device is given the impression that s/he may interact with the website even if being off-line. The actual transaction relating to a selection—e.g., a purchasing decision—is performed if or when the user device connects online again.

It may be noted that the packaging unit 304 and the offering unit may be integrated into the content management system.

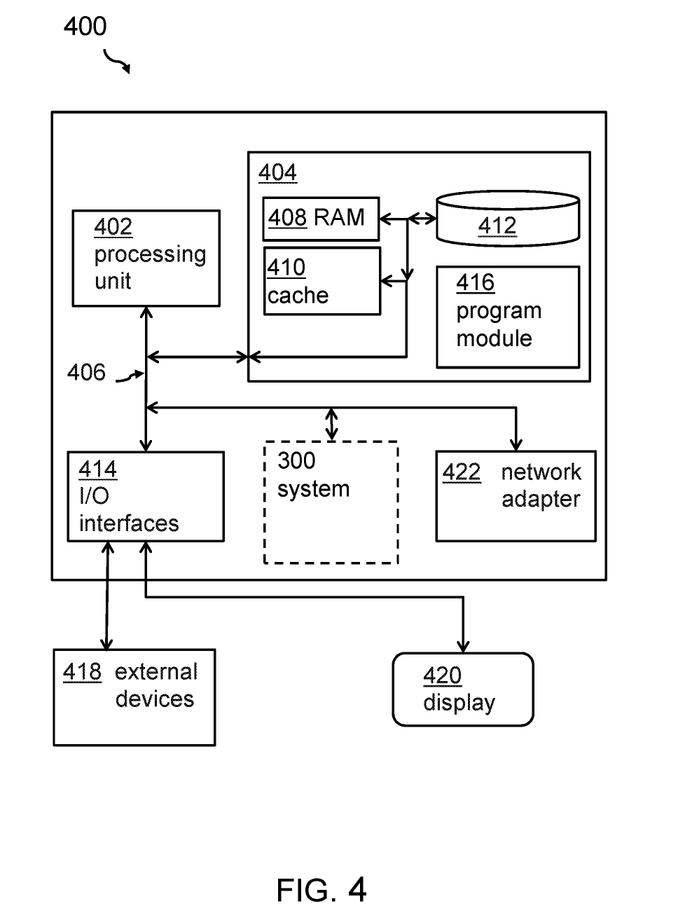

Embodiments of the invention may be implemented together with virtually any type of computer, regardless of the platform being suitable for storing and/or executing program code. FIG. 4 shows, as an example, a computing system 400 suitable for executing program code related to the proposed method, either on the server side or the user device side.

The computing system 400 is only one example of a suitable computer system and is not intended to suggest any limitation as to the scope of use or functionality of embodiments of the invention described herein. Regardless, computer system 400 is capable of being implemented and/or performing any of the functionality set forth hereinabove. In the computer system 400, there are components, which are operational with numerous other general purpose or special purpose computing system environments or configurations. Examples of well-known computing systems, environments, and/or configurations that may be suitable for use with computer system/server 400 include, but are not limited to, personal computer systems, server computer systems, thin clients, thick clients, hand-held or laptop devices, multiprocessor systems, microprocessor-based systems, set top boxes, programmable consumer electronics, network PCs. minicomputer systems, mainframe computer systems, and distributed cloud computing environments that include any of the above systems or devices, and the like. Computer system/server 400 may be described in the general context of computer system-executable instructions, such as program modules, being executed by a computer system 400. Generally, program modules may include routines, programs, objects, components, logic, data structures, and so on that perform particular tasks or implement particular abstract data types. Computer system/server 400 may be practiced in distributed cloud computing environments where tasks are performed by remote processing devices that are linked through a communications network. In a distributed cloud computing environment, program modules may be located in both local and remote computer system storage media including memory storage devices.

As shown in the figure, computer system/server 400 is shown in the form of a general-purpose computing device. The components of computer system/server 400 may include, but are not limited to, one or more processors or processing units 402, a system memory 404, and a bus 406 that couples various system components including system memory 404 to the processor 402. Bus 406 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 400 typically includes a variety of computer system readable media. Such media may be any available media that is accessible by computer system/server 400, and it includes both, volatile and non-volatile media, removable and non-removable media.

The system memory 404 may include computer system readable media in the form of volatile memory, such as random access memory (RAM) 408 and/or cache memory 410. Computer system/server 400 may further include other removable/non-removable, volatile/non-volatile computer system storage media. By way of example only, storage system 412 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 406 by one or more data media interfaces. As will be further depicted and described below, memory 404 may include at least one program product having a set (e.g., at least one) of program modules that are configured to carry out the functions of embodiments of the invention.

Program/utility 414, having a set (at least one) of program modules 416, may be stored in memory 404 by way of example, and not limitation, as well as an operating system, one or more application programs, other program modules, and program data. Each of the operating system, one or more application programs, other program modules, and program data or some combination thereof, may include an implementation of a networking environment. Program modules 416 generally carry out the functions and/or methodologies of embodiments of the invention as described herein.

The computer system/server 400 may also communicate with one or more external devices 418 such as a keyboard, a pointing device, a display 420, etc.: one or more devices that enable a user to interact with computer system/server 400; and/or any devices (e.g., network card, modem, etc.) that enable computer system/server 400 to communicate with one or more other computing devices. Such communication can occur via. Input/Output (I/O) interfaces 414. Still yet, computer system/server 400 may communicate with one or more networks such as a local area network (LAN), a general wide area network (WAN), and/or a public network (e.g., the Internet) via network adapter 422. As depicted, network adapter 422 may communicate with the other components of computer system/server 400 via bus 406. It should be understood that although not shown, other hardware and/or software components could be used in conjunction with computer system/server 400. Examples, include, but are not limited to: microcode, device drivers, redundant processing units, external disk drive arrays, RAID systems, tape drives, and data archival storage systems, etc.

Additionally, system 300 for distributing a content container to a user device may be attached to the bus 406.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus', and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus', or another device to cause a series of operational steps to be performed on the computer, other programmable apparatus or other device to produce a computer implemented process, such that the instructions which execute on the computer, other programmable apparatus', or another device implement the functions/acts specified in the flowchart and/or block diagram block or blocks.

The flowcharts and/or block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

1. A computer-implemented method for distributing a content container to a user device, said method comprising:
creating target web content in a web content management system, wherein said target web content comprises event rules, a buffer, and content pages, wherein the event rules comprise:
at least one rule to determine which content page should be rendered at the user device based on an external variable and said event rules, and
at least one rule to render the determined content page at interpretation time without a connection between said user device and said content management system;
packaging a subset of said content pages into a content container;
offering the subset of content pages in said content container for downloading to said user device; and
storing, in the buffer, an interaction response of an interaction with said content page.

2. The method according to claim 1, further comprising:
when a network connection to said user device has been established, using said interaction response stored in said buffer to interact with an interaction target.

3. The method according to claim 1, wherein said target web content is created using at least one of: HTML, JavaScript, or CSS.

4. The method according to claim 1, wherein said interaction response is targeted to a selection option relating to products and/or services.

5. The method according to claim 1, wherein said external variable comprises at least one selected out of said group comprising a date, a point in time, a location, measured temperature, a measures heartbeat rate, measured humidity, or a device status.

6. The method according to claim 1, wherein said creating said target web content is dependent on a user profile.

7. The method according to claim 1, wherein said packaging said target web content into said content container further comprises packaging an application to be executed on said user device in said content container.

8. The method according to claim 1, wherein said packaging said target web content is prepared individually for each user requesting said package, based on user preferences and on evaluating personalization rules on a web server.

9. The method according to claim 1, wherein said target web content is interpreted by a local HTTP-server for rendering said target web content on said user device.

10. A system for distributing a content container to a user device, said system comprising
a web content management system adapted for creating target web content, wherein said target web content comprises event rules, a buffer, and content pages, wherein the event rules are adapted for:
changing rendered content displayed at interpretation time of said target web content without a connection between said user device and said content management system,
determining which content page should be rendered at the user device based on an external variable and the event rules, and
rendering the determined content page at interpretation time without a connection between the user device and the content management system;
a packaging unit adapted for packaging said content pages into said content container;
an offering module adapted for offering the subset of content pages into said content container for downloading to said user device; and
a buffer for storing an interaction response of an interaction with said content page.

11. The system according to claim 10, wherein said interaction response stored in said buffer is adapted for an interaction with an interaction target when a network connection to said user device has been established.

12. The system according to claim 10, wherein said content management system is also adapted for a creation of said target web content using at least one selected out of the group comprising HTML, JavaScript, or CSS.

13. The system according to claim 10, wherein said interaction response is adapted to be targeted to a selection option relating to products and/or services.

14. The system according to claim 10, wherein the external variable comprises at least one selected out of the group: a date, a point in time, a location, measured temperature, a measured heartbeat rate, measured humidity, or a device status.

15. The system according to claim 10, wherein said content management system is also adapted for using a user profile during said creation of said target web content.

16. The system according to claim 10, wherein said packaging unit for packaging said target web content into said content container is also adapted for packaging an application to be executed on said user device in said content container.

17. The system according to claim 10, wherein said packaging unit for packaging said target web content is also adapted for an individual preparation on each user request of said package, based on said user's preferences and on an evaluation of personalization rules on said web server for said user.

18. The system according to claim 10, wherein said target web content is adapted to be interpreted by a local HTTP-server for rendering said target web content on said user device.

19. A computer program product for distributing a content container to a user device, said computer program product comprising a computer readable storage medium having program instructions embodied therewith, said program instructions being executable by one or more computing systems to cause said one or more computing systems to:
create target web content in a web content management system, wherein said target web content comprises event rules, a buffer, and content pages, wherein the event rules include rules for:
determining which content page should be rendered at the user device based on an external variable and said event rules; and
rendering the determined content page at interpretation time without a connection between said user device and said content management system;
package a subset of said content pages into a content container;
offer the subset of content pages in said content container for downloading to said user device;
store, in the buffer, an interaction response of an interaction with said content page.
